(19) United States
(12) Patent Application Publication
(10) Pub. No.: US 2012/0187674 A1
(43) Pub. Date: Jul. 26, 2012

(54) SECURITY ELEMENT FOR DETECTING AUTHENTICITY

(76) Inventor: Loessl Fariborz Martin Zahedi, Munchen (DE)

(21) Appl. No.: 13/498,280

(22) PCT Filed: Oct. 8, 2010
(86) PCT No.: PCT/DE2010/001180

§ 371 Date: Mar. 26, 2012

(30) Foreign Application Priority Data
Oct. 9, 2009 (DE) DE102009048870.7

(51) Int. Cl. B42D 15/00

(52) U.S. Cl. 283/85

(57) ABSTRACT

The present invention pertains to a security element for authenticity verification, in particular, of security documents, banknotes, valuable documents, coins, chips, commodities, design elements, data carriers and similar objects. The inventive security element comprises a first layer (101) that is transparent to light and has a refractive index n₁, wherein the first side (108) of the first layer (101) has a surface (108) that is provided with a structure (105), a second layer (102) that is arranged on the first layer (101) directly on the structured surface (108) and has a refractive index n₂, wherein n₂≠n₁ applies, particularly n₂>>n₁ or n₂<<n₁, wherein the transmission T of the light through the second layer (102) varies in accordance with a predetermined function T=T(x, y) in dependence on the location in the second layer (102), and wherein x and y are location coordinates in a layer plane of the second layer, as well as a third layer (103) that is transparent to light and contains a luminescent material, wherein this third layer is arranged on the opposite side of the second layer (102) referred to the first layer (101) and connected to the second layer (102) in a light-conductive fashion or arranged on the second side (107) of the first layer (101) that lies opposite of the first side of the first layer (101) and connected to the first layer (101) in a light-conductive fashion.

The present invention pertains to a security element for authenticity verification, in particular, of security documents, banknotes, valuable documents, coins, chips, commodities, design elements, data carriers and similar objects.

Security elements for authenticity verification are known from the state of the art. For example, publication DE 2007 024 298 B3 discloses a security element for authenticity verification that is characterized in that it comprises a light-collecting and light-conductive transparent foil that is colored with daylight-fluorescent dye and contains a motif that is realized by purposefully interfering in the foil's own total internal reflection and luminescent in the visible spectrum under ambient light. Security elements of this type are typically realized in the form of security strips, security surfaces, etc., and connected to security documents, banknotes or similar objects in such a way that the removal of the security element leads to the destruction of the respective object. The security elements are intended to ensure a definite and reliable authenticity verification of the above-described objects connected thereto. In addition, the security elements should be designed in such a way that the duplication or forgery of the security elements and of the objects provided therewith, for example by means of simple copying or similar methods, is largely precluded. Many different security elements are known from the state of the art and typically feature several different layers that contain symbols, barcodes, motifs, images or other optical information, e.g., in the form of an engraving, blackening or hologram. In this case, the optical information contained in the security element may be visible or invisible in dependence on the viewing angle.

The present invention is based on the objective of disclosing a security element for authenticity verification that can be cost-efficiently manufactured, allows a reliable verification of the authenticity and is forgery-proof such that, for example, the security element cannot be simply copied with a commercially available copier.

The invention is defined by the characteristics of independent Claim 1. Advantageous additional developments and embodiments form the objects of the dependent claims. Other characteristics, possible applications and advantages of the invention result from the following description, as well as the explanation of exemplary embodiments of the invention that are illustrated in the figures.

The objective of the invention is attained with a security element for authenticity verification, particularly of security documents, cash or similar objects, that features a first layer that is transparent to light and has a refractive index n₁, wherein the first side of the first layer has a surface that is provided with a structure, a second layer that is arranged on the first layer directly on the structured surface and has a refractive index n₂, wherein n₂≠n₁ applies, particularly n₂>>n₁ or n₂<<n₁, wherein the transmission T of the light through the second layer varies in accordance with a predetermined function T=T(x, y) in dependence on the location in the second layer, and wherein x and y are location coordinates in a layer plane of the second layer, as well as a third layer that is transparent to light and contains a luminescent material, wherein this third layer is arranged on the opposite side of the second layer referred to the first layer and connected to the second layer in a light-conductive fashion or arranged on the second side of the first layer that lies opposite of the first side of the first layer and connected to the first layer in a light-conductive fashion.

It was determined that such a security element makes it possible to achieve optical effects that are dependent on the viewing angle such that the security element cannot be simply forged, e.g., by copying a banknote provided with the inventive security element on a commercially available copier. In addition, the security element can be cost-efficiently manufactured.

The security element is preferably realized in the form of a strip or flat element and applied onto the object, the authenticity of which it should verify, in such a way that the third layer is arranged closest to the object, e.g., glued on the banknote. In this case, the security element may be arranged on the surface of the respective object or it may be incorporated into the object.

The inventive security element that comprises at least the three above-described layers has a thickness of <100 μm, preferably <50 μm, particularly a thickness between 5 and 30 μm. This thickness corresponds, in particular, to the thickness of conventional security strips that are nowadays used in banknotes. The entire security element preferably is flexible, i.e. bendable, such that the security element can also be used on bendable objects such as banknotes, security papers, etc., and therefore rolled up or folded in a largely damage-free fashion and without losing its security or authenticity verification function.

The above-described characteristics of the inventive security element pertaining to light such as “transparent to light,” “transmission of the light” and “connected in a light-conductive fashion” refer to electromagnetic radiation with wavelengths in the range between 1 nm and 1000 nm, particularly in the range between 380 and 780 nm, i.e., the visible light spectrum. In another preferred embodiment of the security element for authenticity verification, the characteristics pertaining to light refer to electromagnetic radiation with wavelengths in the range between 1 nm and 380 nm, i.e., particularly to ultraviolet radiation that is invisible to the eye and only recognizable with corresponding UV light sources or UV sensors, respectively. This embodiment is suitable for applications, in which the authenticity verification should not be possible for everyone and the special means mentioned above are required for the authenticity verification.

According to the invention, the security element for authenticity verification consists of three layers. In this case, the first layer has a structured surface on its first side. In the present description, the term “structure” is broadly defined, particularly with respect to the shapes of the structure. The structure consists, e.g., of a predetermined arrangement (pattern, etc.) of elevations and depressions with predetermined shapes (edges, curvatures, etc.) on the surface of the underside of the first layer. It is particularly preferred that the structure has a concentric, elliptical, parallel, trapezoidal or stellate geometry. It is also particularly preferred that the structure is realized in the form of the annular step structure of a Fresnel lens.

In another preferred embodiment of the security element, the structure is realized in the form of the annular structure of a Fresnel zone plate. In this case, the structure features concentric rings that differ with respect to their transparency and/or the length of their optical path through the first layer. For example, zone plates with binary gradation are known, wherein transparent ring zones alternate with opaque ring zones, i.e., completely absorbing ring zones. The incident light is distributed over many real and virtual focal points. In one instance, the light may be refracted on the annular gap structures and amplified due to constructive interference in the focal points. In the other instance, the ring zones are replaced with a transparent material of exactly defined thickness (resulting in cross-sectionally alternating rectangular structures) such that a phase shift of the light wave by 180° is achieved and the light transmitted through the first layer constructively interferes in the focal point.

Due to the structured surface on the first side of the first layer, optical effects are produced in dependence on the viewing angle when looking at the second side of the first layer, wherein these optical effects have, for example, the effect of a lens or give the viewer a three-dimensional impression and only make it possible to recognize optical information contained in the security element at certain viewing angles. These optical effects are produced due to the refraction of light on the structured surface. The structure may furthermore be realized in such a way that diffraction effects are produced as it is the case with the Fresnel zone plate. In the security element, the thickness of the light-transparent first layer preferably amounts to the largest part of the thickness of the security element, for example one half to two thirds of the security element thickness. The second side of the first layer is preferably level (plane) and not structured. A mechanically resistant protective layer that is transparent to light may be applied onto the second side of the first layer as protection against wear.

According to the invention, a second layer is respectively applied or arranged on the first layer, in particular, directly on the structured surface on the first side of the first layer. According to the invention, the transmission T of the light through this second layer varies in accordance with a predetermined continuous function T=T(x, y) in dependence on the location in the second layer, wherein x and y are location coordinates in the layer plane. In addition, the first layer has a refractive index n₁ and the second layer has a refractive index n₂, wherein n₂≠n₁, particularly n₂>>n₁ or n₂<<n₁, applies in accordance with the invention. If n₂=n₁, the optical effect of the structure of the first layer would not manifest itself because no refraction of the light would occur at the transition from the first layer to the second layer in this case. The distinctiveness of the optical effect of the structure, i.e., the perceptibility for a viewer, therefore increases proportionally to the difference between the refractive indices. A person skilled in the art can respectively influence or vary the desired optical effect of the corresponding structure by choosing the materials for the first and the second layer accordingly.

In the present description, the term transmission refers to the transmissivity of a medium (e.g., of the second layer) for electromagnetic waves (light). The transmission is preferably indicated in the form of the transmission factor (in English “transmittance”) [0-100%] that is defined as the quotient of the wave intensity before and after passing through the medium. In this case, special optical effects can be achieved by also taking into account the transmission that is dependent on the wavelength and on the angle of incidence of the light in the selection of the materials for the three layers and by utilizing this transmission for realizing the optical effects.

One preferred embodiment of the inventive security element is characterized in that the second layer contains metallic elements or consists entirely of metallic elements, the concentration C(x, y) of which varies in dependence on the location in the layer plane in such a way that the transmission T varies in accordance with the function T=T(x, y).

Another preferred embodiment of the inventive security element is characterized in that the second layer contains metallic elements or consists entirely of metallic elements and the thickness D(x, y) of the second layer varies in dependence on the location in the layer plane in such a way that the transmission T varies in accordance with the function T=T(x, y).

The application of the metallic elements onto the structured surface is realized, e.g., in the form of a vapor deposition of a metallic layer that respectively has a different layer thickness D(x, y) or a different concentration C(x, y) onto the structured surface of the first layer. The applied metal layer is so thin that it is at least partially transparent to light. All elements of the periodic system and element compositions that are assigned to the group of metals, as well as compositions that contain metallic elements, basically may be considered as metallic elements. For example, the following metals are particularly suitable: Al, Cr, Ni, Zn, Cu, Hg and Au.

In one simple and preferred embodiment of the inventive security element, the transmission T(x, y) through the second layer respectively decreases or increases linearly along at least one horizontal direction in the second layer (layer plane). However, the variation of the transmission T(x, y) in the second layer may, according to the invention, be defined by any continuous function, wherein desirable optical effects rather occur with simple functions: linear functions, sine/cosine functions, etc. The transmission T(x, y) may vary in the range between 0-100%, preferably in the range between 30-100%, particularly in the range between 40-90%.

According to the invention, the security element for authenticity verification furthermore features a third layer that is transparent to light and contains luminescent material, wherein this third layer is arranged on the opposite side of the second layer referred the first layer and connected to the second layer in a light-conductive fashion or arranged on the second side of the first layer that lies opposite of the first side of the first layer and connected to the first layer in a light-conductive fashion. Light that is incident on the third layer through the first and the second layer excites the luminescent material present at this location, wherein the material preferably fluoresces in order to be luminescent with a wavelength that is dependent on the material (dye). Due to the light-conductive connection, this luminescence light is respectively transmitted from the third layer to the second layer and from the second layer to the first layer or from the third layer to the first layer and then to the second layer. When looking at the security element, the luminescence light once again produces a colorful optical effect that is dependent on the viewing angle and cannot be reproduced by simply copying the security element on a conventional copier. The attainable optical effects result from the interaction of the three inventive layers of the security element.

The third layer preferably is directly arranged or applied on the side of the second layer that lies opposite of the first layer. In one preferred embodiment of the inventive security element, a motif is produced in the third layer by purposefully interfering in the foil's own total internal reflection. In this respect, the term “motif” is broadly defined. It comprises, in particular, any optically readable information such as symbols, images, barcodes, 2-dimensional or 3-dimensional codes, etc. The methods disclosed in publication DE 10 2007 024 298 B3, for example laser processing, laser engraving, steel relief embossing, intaglio printing, etc., are particularly suitable for producing the motif or motifs.

Due to the interference in the layer's own total internal reflection, the luminescence light is deflected at the respective interference points. The interference points are preferably produced in such a way that they represent a motif in the third layer, i.e., an image, a signal code or one or more arbitrary symbols. The luminescence light is deflected from the third layer in the direction of the second and the first layer at the interference points that ultimately reflect the motif, etc. Depending on the optical effect produced by the structure of the first layer, a viewer therefore is able to recognize the motif, etc., in dependence on the viewing angle.

In another preferred embodiment of the inventive security element, a fourth layer that is transparent to light is arranged between the third layer and a layer composite consisting of the first layer and the second layer, wherein a motif is produced in this fourth layer by purposefully interfering in the layer's own total internal reflection.

Naturally, other layers that preferably are completely transparent to light may be arranged between the aforementioned layer composite and the third layer. These layers may consist, in particular, of adhesive layers, for example a UV-hardening adhesive. It is possible, in particular, to realize these layers in the form of layers that fluoresce in different colors.

In one exemplary embodiment, a combination of three layers containing dyes that respectively fluoresce differently is provided instead of the third layer. In this case, a layer that fluoresces in blue (B), then a layer that fluoresces in green (G) and ultimately a layer that fluoresces in red (R) are arranged, e.g., on the second layer (in the direction away from the first layer). Special optical effects can be achieved by producing motifs, etc., that are geometrically aligned relative to one another and jointly produce a complete motif in all three above-described fluorescent layers (B-G-R). In this case, interferences in the total internal reflection of the respective layers that are produced in the individual layers and lie on top of one another in the layer composite may respectively code or illuminate the complete motif with different colors, particularly give the impression of white illumination.

Other advantages, characteristics and details of the invention result from the following description, in which one exemplary embodiment is described in detail with reference to the drawings.

In these drawings:

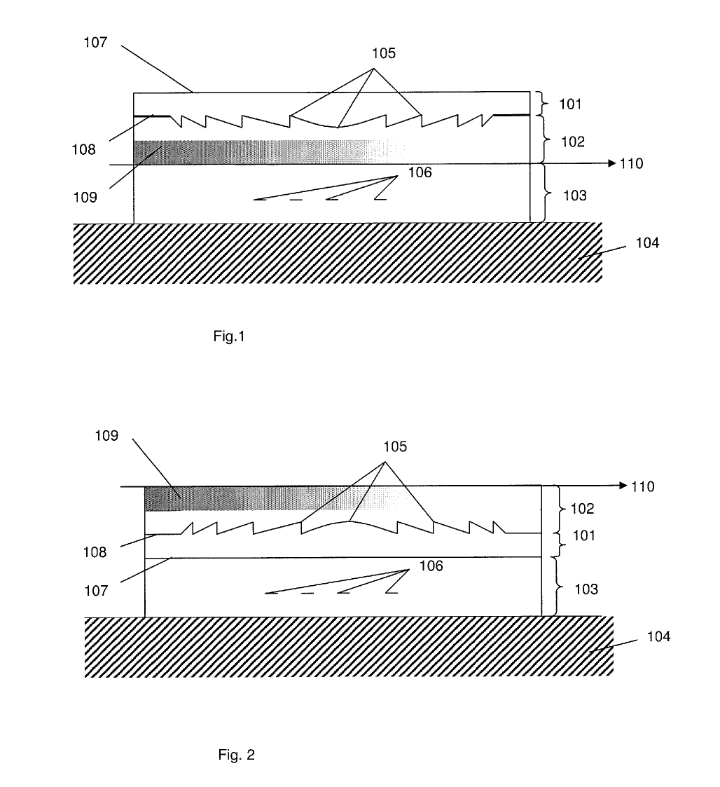

FIG. 1 shows a schematic cross-sectional representation of a first embodiment of an inventive security element that is applied onto a banknote, and

FIG. 2 shows a schematic cross-sectional representation of a second embodiment of an inventive security element that is applied onto a banknote.

FIG. 1 shows a schematic cross section along the x-axis of one embodiment of an inventive security element that is applied onto a banknote 104 and serves for the authenticity verification thereof. In this case, the y-axis extends perpendicular to the plane of projection and into the plane of projection. This security element consists of three layers 101-103 and is applied onto the banknote 104 with the third layer 103 in such a way that the separation of the security element would lead to the destruction of the banknote 104. The first layer 101 of the security element consists of a material with a refractive index n₁, wherein the underside 108 of the first layer 101 features a structure 105, namely the distinctive annular structure of a Fresnel lens.

The second layer 102 of the security element is arranged underneath the first layer 101 directly on the structured surface 108 and consists of a material with an (overall) refractive index n₂, wherein n₂≠n₁ applies, particularly n₂>>n₁ or n₂<<n₁. In addition, this second layer 102 contains one or more metallic elements, the concentration of which decreases from the left to the right in the illustrated cross section through the security element, wherein the concentration distribution is chosen such that the transmission T of the light through the second layer 102 varies in the direction of the x-axis from the left cross-sectional side to the right cross-sectional side in accordance with a predetermined continuous function T=T(x, y), namely a linear increase of the transmission in this case. In FIG. 1, the described varying concentration distribution C(x, y) is illustrated in the form of a strip 109, in which the gray scale value decreases from the left toward the right. Naturally, the concentration distribution of the metallic elements may be locally constant over the thickness of the second layer such that the following applies in this case:

$$\frac{\partial C ( x , y , z )}{\partial x} = konst . , \frac{\partial C ( x , y , z )}{\partial y} = 0 , \frac{\partial C ( x , y , z )}{\partial z} = 0 ,$$

wherein x, y and z are three-dimensional location coordinates in the second layer.

In the present example, a layer that contains copper or aluminum with a one dimensional local concentration C(x, y), i.e., a local concentration that varies in the direction of the x-axis, is accordingly applied onto the structured surface 108 such that the transmission through the second layer changes linearly along the x-axis in the region of the structure 105, namely from 30% on the left to 80% on the right.

In this case, the third layer 103 that is transparent to light contains, e.g., a material that luminesces in red, wherein this layer is arranged on the opposite side of the second layer 102 referred to the first layer 101 and connected to the second layer 102 in a light-conductive fashion. In addition, a motif 106 such as, e.g., text is produced in the third layer 103 by purposefully interfering in the layer's own total internal reflection by means of a laser. When looking at the upper side 107 of the security element, e.g., in daylight, the motif (text) that luminesces in red is visible in a perceived three dimensional spherical space within a certain viewing angle range.

The described security element makes it possible to realize various optical effects in dependence on the chosen structuring of the underside of the first layer 101, the chosen difference between the refractive indices of the first layer and the second layer, the chosen variation of the two-dimensional transmission T(x, y) over the second layer 102, the chosen luminescent material of the third layer 103, as well as the additional arrangement of motifs or optical information in one of the three layers or in other light-conductive layers arranged between the second and the third layer. The security element is largely forgery-proof and can be inexpensively manufactured.

The structure 105 produces an optical effect, particularly a magnifying lens effect, a latent image effect, a distortion effect, etc., when looking at the motif 106. Furthermore, the structure 105 may act as optical outcoupling of a total internal reflection that occurs within the entire security element, particularly on the surface 107, such that the structure 105 also appears brighter than a surrounding region of the first layer 101 that is realized, in particular, in a plane fashion, i.e., not structured.

FIG. 2 shows a schematic cross section through a second embodiment of an inventive security element that is applied onto a banknote. This second embodiment merely can be distinguished from the embodiment illustrated in FIG. 1 in that the layers 101 and 102 are interchanged in the security element. In this case, it is possible to provide the second layer 102 that faces the viewer with a protective layer, particularly in the form of a protective lacquer that is preferably completely transparent to light. In other respects, we refer to the preceding description of FIG. 1.

### LIST OF REFERENCE SYMBOLS

101 First layer
102 Second layer
103 Third layer
104 Banknote or, in general, object
105 Structure
106 Motif, symbol, optical information, etc. produced by purposefully interfering in the layer's own total internal reflection
107 Second side of first layer
108 First side of first layer
109 Schematic representation of an embodiment, in which the second layer contains metallic elements, the concentration of which decreases from the left toward the right in the illustrated cross section through the security element
110 X-axis in the layer plane of the second layer

1. A security element for authenticity verification of objects, the security element comprising:
a first layer that is transparent to light and has a refractive index n₁, wherein a first side of the first layer has a surface provided with a structure;
a second layer that is arranged on the first layer directly on the structure and has a refractive index n₂, wherein n₂≠n₁ applies, wherein transmission T of light through the second layer varies in accordance with a predetermined function T=T(x, y) in dependence on location in the second layer, and wherein x and y are location coordinates in a layer plane of the second layer; and
a third layer that is transparent to light and contains a luminescent material, wherein this third layer is arranged on the opposite side of the second layer referred to the first layer and connected to the second layer in a light conductive fashion or arranged on the second side of the first layer that lies opposite to the first side of the first layer and connected to the first layer in a light-conductive fashion.

2. The security element according to claim 1, wherein the second layer includes metallic elements, wherein concentration C(x, y) of the metallic elements varies in the layer plane in dependence on the location in such a way that the transmission T varies in accordance with the predetermined function T=T(x, y).

3. The security element according to claim 1, wherein the second layer includes metallic elements and thickness D(x, y) of the second layer varies in the layer plane in dependence on the location in such a way that the transmission T varies in accordance with the predetermined function T=T(x, y).

4. The security element according to claim 1, wherein the security element has a thickness of <100 μm.

5. The security element according to claim 1, wherein the light consists of electromagnetic radiation with wavelengths in a range between 1 nm and 1000 nm.

6. The security element according to claim 1, wherein the luminescent material is fluorescent.

7. The security element according to claim 1, wherein geometry of the structure is one of concentric, elliptical, parallel, trapezoidal and stellate.

8. The security element according to claim 1, wherein the structure has an annular step structure of a Fresnel lens.

9. The security element according to claim 1, wherein the structure has an annular structure of a Fresnel zone plate.

10. The security element according to claim 1, wherein the transmission T of the second layer linearly decreases in at least one horizontal direction of the second layer.

11. The security element according to claim 1, wherein a motif is produced in the third layer by purposefully interfering in the layer's own total internal reflection.

12. The security element according to claim 1, further comprising a fourth layer that is transparent to light and is arranged between the third layer and a layer composite including the first layer and the second layer, wherein a motif is produced in the fourth layer by purposefully interfering in the layer's own total internal reflection.

13. The security element according to claim 1, wherein the third layer is directly arranged on the opposite side of the second layer referred to the first layer.

14. The security element according to claim 1, wherein one inequality of n₂>>n₁ and n₂<<n₁ applies.

15. The security element according to claim 1, wherein the security element has a thickness of <50 μm.

16. The security element according to claim 1, wherein the security element has a thickness of 5 μm-30 μm.

17. The security element according to claim 1, wherein the second layer is a metallic layer deposited onto the structure of the first layer.

18. The security element according to claim 17, wherein at least one of thickness and density of the metallic layer varies linearly along the metallic layer to vary transparency to light.

19. The security element according to claim 17, wherein the metallic layer is partially transparent to light.

20. The security element according to claim 19, wherein transparency of the metallic layer varies linearly along the metallic layer.
